(19) United States
(12) Patent Application Publication
(10) Pub. No.: US 2010/0219963 A1
(43) Pub. Date: Sep. 2, 2010

(54) APPARATUS FOR INDICATING THE STATE OF CHARGE OF A STORAGE BATTERY

(76) Inventors: Alexander Osswald, Stuttgart (DE); Thomas Heinrich, Leinfelden (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/667,816

(22) PCT Filed: May 16, 2008
(86) PCT No.: PCT/EP08/56045

§ 371 Date: Apr. 20, 2010

(30) Foreign Application Priority Data
Jul. 6, 2007 (DE) 102007031566.1

(51) Int. Cl. G08B 21/00

(52) U.S. Cl. 340/636.1

(57) ABSTRACT

Storage batteries having a rechargeable battery for operating electric tools often have a state of charge indicator. A state of charge circuit, which has a sensor that is coupled to the evaluation unit, is provided in order to identify the operating state of the storage battery. An interlock switch for preventing indication of the state of the charge is coupled to the evaluation unit. If charging or discharging of the rechargeable battery is identified using the sensor, the interlock switch is used to prevent indication of the current state of charge.

The invention relates to an accumulator for a power tool, having a rechargeable battery equipped with a charge state circuit, which has an evaluation unit for evaluating the charge state of the accumulator and has a charge state display. The invention also relates to a method for displaying the charge state of a rechargeable battery of an accumulator equipped with a charge state circuit, which has an evaluation unit for evaluating the charge state of the accumulator and has a charge state display.

Various types and sizes of rechargeable batteries are currently available for a multitude of applications. Typical types of such rechargeable batteries, referred to by the components they contain, include for example lead acid, nickel cadmium (NiCd), nickel metal hydride (NiMH), lithium-ion (LiIo) or lithium polymer batteries. These can be used multiple times and recharged in a suitable charging unit.

In the context of the present application, an “accumulator” is understood to be a rechargeable battery that, in addition to the rechargeable battery or the rechargeable battery pack itself, contains at least one additional component such as an electronic circuit, electrical connections, or a locking mechanism for connection to a power tool. In accumulators of this kind, a charge state display can be provided, which can be used to inform the user of the charge state of the accumulator. In this connection, the charge state can be displayed in various ways. For example, this can be accomplished by means of a single LED that indicates a ready-to-operate charge state by means of a green color, for example. It is also possible to use a plurality of LEDs to implement a more precise display of the charge state; for example, a plurality of LEDs is provided and different numbers of them light up in accordance with the particular charge state.

For this purpose, DE 4 106 725 A1, for example, has disclosed an accumulator with a circuit arrangement for displaying the charge state for rechargeable batteries. These can, for example, be used to operate a machine, in particular a hand-held power tool such as a cordless drill or cordless screwdriver. In this case, the charge state of the battery is determined through an integration of a current flowing in the load circuit. The respective current charge state is displayed by means of a charge state display. The charge state is displayed in or on the housing of the battery; for example four LEDs can indicate the current charge state in 25% stages. Embodying the charge state display as manually activatable and deactivatable is also known from this document.

Often, the charge state display is supported by a microprocessor, which makes sure that a communication can take place between the accumulator, the charging unit, and the machine operated with the accumulator. If this communication reveals that the rechargeable batteries are currently being charged or are currently being discharged by the machine, then the charge state display is locked and the user is informed that a display of the charge state is not currently possible. If such a microprocessor is not to be used in the charge state display, for example for cost reasons, then as a result, it is not possible to distinguish among the various operating states and the charge state display indicates incorrect values.

According to the invention, a charge state display is now proposed, which has a circuit arrangement that permits an output of the correct value of the charge state without requiring the provision of a microprocessor for determining the operating state. To this end, the charge state circuit is provided with a sensor that is coupled to the evaluation unit. In addition, an interlock switch that is coupled to the evaluation unit is provided for locking the display of the charge state.

In a preferred embodiment, the sensor can be embodied so that it has contacts at which a voltage can be evaluated. In particular, the sensor can be embodied in the form of an NTC in which a voltage level is sensed at its contacts. If the voltage level of the NTC is greater than a predetermined threshold value, then this means that the accumulator is either being discharged by the machine it, is powering, i.e. the machine is being operated, or that the accumulator is currently being charged by a charging unit. In both cases, the charge state is not displayed.

In another embodiment of the invention, the sensor for detecting whether the rechargeable battery is being charged or discharged can also be magnetically embodied.

The accumulator according to the invention therefore has a rechargeable battery equipped with a charge state circuit, which has an evaluation unit for evaluating the charge state of the rechargeable battery and has a charge state display. The charge state circuit is equipped with a sensor that is coupled to the evaluation unit. In addition, an interlock switch that is coupled to the evaluation unit is provided for preventing the display of the charge state.

Consequently the functionality for determining the operating state can be provided by means of an inexpensive electronic circuit arrangement in the accumulator.

To prevent a constant displaying of the charge state, preferably an activation switch is provided for activating the charge state circuit. The sensor can easily be implemented in the fog fn of an NTC; this is preferably provided in the vicinity of the rechargeable battery. The voltage level of the voltage present in the NTC indicates whether the rechargeable battery is currently being charged or discharged.

In another preferred embodiment of the invention, a voltage monitoring of the rechargeable battery is integrated into the evaluation unit. It is thus possible to detect if the voltage of the rechargeable battery falls below a minimum voltage. In this case, the interlock switch can be switched so that a display is prevented and the accumulator can thus be protected from a total discharge.

With the accumulator according to the invention, it is thus possible to activate the charge state circuit by means of an activation switch. The sensor is able to detect whether the rechargeable battery is being charged or discharged. Depending on the measurement result, it is then possible to deactivate an interlock switch in the evaluation unit and thus enable a display of the charge state of the rechargeable battery or to activate the interlock switch and thus prevent the display.

This method can be implemented with particular ease if the voltage in a suitably arranged NTC is evaluated. If the voltage in the NTC lies above a threshold value, e.g. greater than zero, then this means that the accumulator is either being charged or is being discharged by the operation of the machine. The interlock switch then prevents a display of the current charge state. if the voltage is less than or equal to a threshold value, e.g. less than or equal to zero, then the interlock switch is deactivated and the current charge state is displayed.

Other advantages and advantageous embodiments of the invention are the subject of the following figures and the passages describing them.

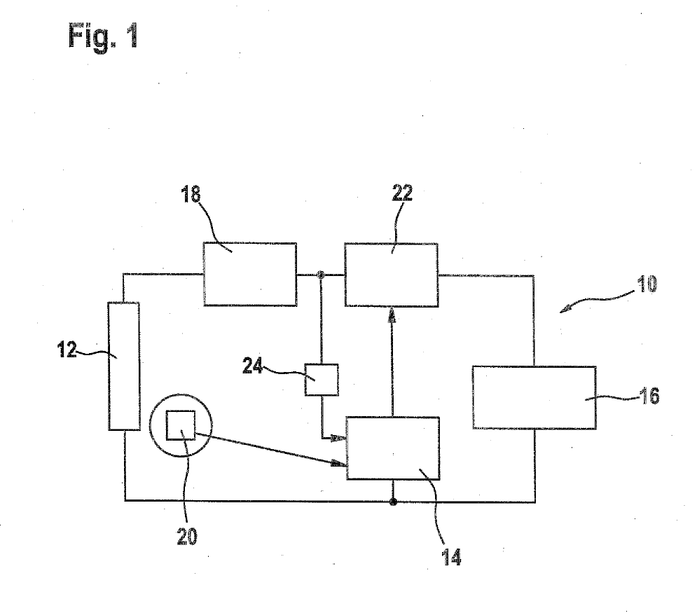

FIG. 1 schematically depicts a charge state circuit

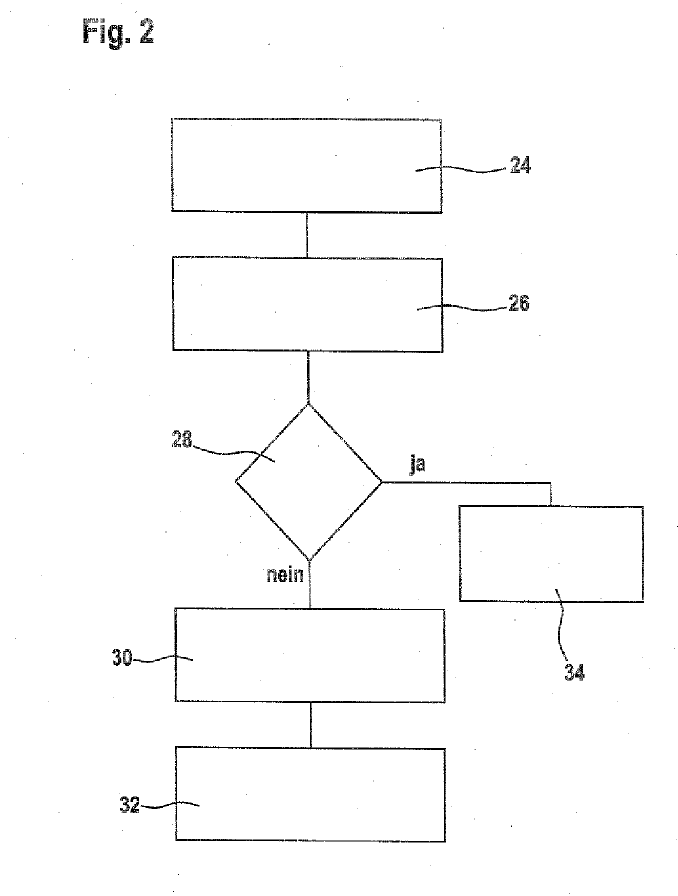

FIG. 2 schematically depicts the sequence of the method according to the invention

FIG. 1 schematically depicts a charge state circuit 10 with a rechargeable battery 12. An activation switch 18, which is embodied as a mechanical push-button, can be provided in the circuit. If the activation switch 18 is pressed, then the charge state circuit 10 and therefore an evaluation unit 14 is supplied with current. By means of a sensor 20, the evaluation unit 14 checks whether the rechargeable battery is currently being charged or discharged. Preferably, this can take place by embodying the sensor 20 in the form of an NTC that is connected to the evaluation unit 14. In this case, the evaluation unit 14 checks the voltage level in the NTC and compares it to a predetermined threshold value. For example, the evaluation unit 14 can check whether a voltage is present in the NTC. If this is the case, then the accumulator is either connected to a charging unit and is being charged or the accumulator is being used in a machine and the rechargeable battery 12 is currently being discharged. If so, an interlock switch 22 provided in the charge state circuit is activated and a display of the current charge state in the charge state display 16 provided in the circuit 10 is prevented.

If the check in the evaluation unit 14 determines that there is no voltage present in the NTC, then the rechargeable battery 12 is being neither charged nor discharged currently and the currently determined charge state can be displayed in the charge state display 16. Consequently, the evaluation unit 14 deactivates the interlock switch 22 and enables the display. The charge state can be determined in a way already known from the prior art.

To further improve the charge state circuit 10, a voltage monitoring can be integrated into the evaluation unit 14. To this end, the drawing schematically depicts a voltage measurement 24 with which it is possible to measure a respective voltage currently present in the rechargeable battery 12 and to process it in the evaluation unit 14. If it has been determined that the voltage of the rechargeable battery 12 lies below a minimum value, then the interlock switch is likewise activated, thus making it possible to prevent the rechargeable battery 12 from being totally discharged. A discharged accumulator therefore no longer has to power a charge state display and is protected from a total discharge.

Once again in schematic fashion, FIG. 2 depicts the basic sequence of the method according to the invention. In step 26, a user activates the charge state display by pressing a [ ] provided on the accumulator using an activation switch 18. Then the evaluation unit 14 is supplied with current. The evaluation unit 14 checks whether the accumulator is currently being charged or discharged. This is carried out in step 26, for example with the aid of a sensor provided on the rechargeable battery 12; preferably, the voltage signal of an NTC suitably attached to the rechargeable battery 12 is evaluated. In step 28, a check is then performed as to whether the evaluation of the temperature signal indicates the charging or discharging operating state of the rechargeable battery 12. If so, the interlock switch 22 is activated in step 34 and a display of the current charge state is prevented.

If it is determined in step 28 that neither a charging nor a discharging of the rechargeable battery 12 is currently occurring, then the interlock switch 22 is deactivated in step 30. The current charge state of the accumulator is then displayed in step 32.

When determining whether the interlock switch 22 should be activated or deactivated, other criteria can also be taken into account in the evaluation unit 14. In particular, an integrated voltage measurement can be used to prevent a deactivation of the interlock switch 22 if it is determined that the rechargeable battery 12 is already discharged.

The accumulator according to the invention, which has the above-described charge state circuit 10, provides an inexpensive electronic circuit that can be used to implement the functionality of much more complex circuit arrangements. It is nevertheless possible to take the particular operating state into account in the display of the respective charge state.

1-9. (canceled)

10. An accumulator for a power tool, having a rechargeable battery equipped with a charge state circuit, the charge state circuit comprising:
an evaluation unit for evaluating the charge state of the accumulator;
a charge state display;
a sensor coupled to the evaluation unit which is able to determine whether the battery is being charged or discharged; and
an interlock switch coupled to the evaluation unit which prevents the charge state display from a display of the charge state.

11. The accumulator as recited in claim 10, wherein an activation switch is provided for activating the charge state circuit.

12. The accumulator as recited in claim 10, wherein the sensor has an element with contacts, in particular is embodied in the form of an NTC whose voltage is able to be evaluated.

13. The accumulator as recited in claim 11, wherein the sensor has an element with contacts, in particular is embodied in the form of an NTC whose voltage is able to be evaluated.

14. The accumulator as recited in claim 10, wherein the sensor is magnetically embodied.

15. The accumulator as recited in claim 11, wherein the sensor is magnetically embodied.

16. The accumulator as recited in claim 12, wherein the sensor is magnetically embodied.

17. The accumulator as recited in claim 13, wherein the sensor is magnetically embodied.

18. The accumulator as recited in claim 10, wherein a voltage monitoring of the rechargeable battery is integrated into the evaluation unit.

19. The accumulator as recited in claim 11, wherein a voltage monitoring of the rechargeable battery is integrated into the evaluation unit.

20. The accumulator as recited in claim 12, wherein a voltage monitoring of the rechargeable battery is integrated into the evaluation unit.

21. The accumulator as recited in claim 13, wherein a voltage monitoring of the rechargeable battery is integrated into the evaluation unit.

22. The accumulator as recited in claim 14, wherein a voltage monitoring of the rechargeable battery is integrated into the evaluation unit.

23. The accumulator as recited in claim 15, wherein a voltage monitoring of the rechargeable battery is integrated into the evaluation unit.

24. The accumulator as recited in claim 16, wherein a voltage monitoring of the rechargeable battery is integrated into the evaluation unit.

25. The accumulator as recited in claim 17, wherein a voltage monitoring of the rechargeable battery is integrated into the evaluation unit.

26. A method for displaying the charge state of a rechargeable battery of an accumulator, the rechargeable battery being equipped with a charge state circuit having an evaluation unit for evaluating the charge state of the accumulator and having a charge state display, the method comprising the steps of:
switching an activation switch of the charge state circuit which activates the charge state circuit;
using a sensor of the charge state circuit to determine whether the battery is being charged or discharged; and
deactivating an interlock switch in the evaluation unit thus enabling a display of the charge state of the rechargeable battery if the rechargeable battery is not being charged or discharged, or else
activating the interlock switch thus preventing the display if the rechargeable battery is being charged or discharged.

27. The method as recited in claim 26, wherein a voltage at contacts, in particular a voltage at contacts of an NTC, is evaluated in order to determine whether the rechargeable battery is being charged or discharged.

28. The method as recited in claim 27, wherein the evaluation unit switches the interlock switch so that a charge state display is prevented if the voltage in the NTC is greater than a threshold value, in particular is greater than zero.

29. The method as recited in claim 28, wherein the evaluation unit switches the interlock switch so that a charge state display is enabled if the voltage in the NTC is less than or equal to a threshold value, in particular is equal to zero.
